(19) United States
(12) Patent Application Publication
(10) Pub. No.: US 2017/0127876 A1
(43) Pub. Date: May 11, 2017

(54) MACHINE FOR PREPARING BEVERAGES WITH FROTHED MILK, IN PARTICULAR CAPPUCCINO OR LATTE MACCHIATO

(71) Applicant: ILLYCAFFE' SPA, Trieste (IT)

(72) Inventors: Franciscus Benedictus Maria VAN EEDEN, Trieste (IT); Claudio GIACHIN, Trieste (IT); Bruno DELLAPIETRA, Duino-aurisina (IT); Diego BALESTIER, Trieste (IT)

(73) Assignee: ILLYCAFFE' SPA, Trieste (IT)

(21) Appl. No.: 15/321,872

(22) PCT Filed: May 14, 2015
(86) PCT No.: PCT/EP2015/060729

§ 371 Date: Dec. 23, 2016

(30) Foreign Application Priority Data
Jun. 27, 2014 (IT) MI2014A001171

(51) Int. Cl. A47J 31/44; A47J 31/46; A47J 31/40

(52) U.S. Cl. CPC A47J 31/4485; A47J 31/407; A47J 31/46

(57) ABSTRACT

A machine for preparing beverages with frothed milk, which comprises a base structure adapted to dispense a beverage and provided with a dispensing head below which there is a dispensing region in which it is possible to arrange a container for collecting the dispensed beverage; the base structure comprises a steam outlet and a milk reservoir that can be separated from the base structure comprising a lid; the base structure comprises a Venturi block that can be separated from the base structure and is connected to the steam outlet and to the milk reservoir in order to draw the milk from the milk reservoir by the Venturi effect and to produce frothed milk; the Venturi block is interposed between the dispensing head and the lid of the milk reservoir and is connected detachably to the lid of the milk reservoir in a lateral position with respect to the lid.

The present invention relates to a machine for preparing beverages with frothed milk, in particular cappuccino or latte macchiato.

Machines for preparing coffee espresso, in particular for domestic use, are evolving with increasingly numerous features. One of these is the ability to use the same machine for preparing not just espresso coffee, but also cappuccino, which usually could be done by providing a wand in the machine for frothing the milk contained in a jug that is not part of the machine.

Considering that a certain level of ability is required of the user in order to effectively froth the milk using the wand, U.S. Pat. No. 5,473,972 proposed to incorporate a reservoir for the milk into the machine and to use the steam generator of the machine, together with a Venturi system, to draw the milk from the reservoir, froth it and dispense it directly into the cup. The Venturi system in this known solution can be incorporated in the machine or in the lid of the reservoir, which advantageously can be separated in order to be conserved, for example, in a refrigerator.

A drawback associated with this type of solution is that the nozzle for dispensing the milk into the cup is difficult to clean, in that it is incorporated in the body shell of the machine.

Furthermore, the fixing of the reservoir to the Venturi system can be inconvenient, in that it is difficult for the user to manage to see the coupling point for the milk riser connected to the lid of the reservoir.

The aim of the present invention is to provide a machine for preparing beverages with frothed milk, in particular cappuccino or latte macchiato, which is capable of improving the prior art in one or more of the above mentioned aspects.

Within this aim, an object of the invention is to provide a machine for preparing beverages with frothed milk which can be washed easily.

Another object of the invention is to provide a machine for preparing beverages with frothed milk in which the mounting of the milk reservoir on the machine is easy and smooth.

Another object of the invention is to provide a machine for preparing beverages with frothed milk in which cleaning and/or maintenance operations are simplified with respect to the prior art.

Another object of the invention is to provide a machine for preparing beverages with frothed milk which is highly reliable, easy to implement and low cost.

This aim and these and other objects which will become better apparent hereinafter are all achieved by a machine for the preparation of cappuccinos according to claim 1, optionally with one or more of the characteristics of the dependent claims.

Further characteristics and advantages of the invention will become better apparent from the description of preferred, but not exclusive, embodiments of the machine for preparing beverages with frothed milk according to the invention, which are illustrated for the purposes of non-limiting example in the accompanying drawings wherein:

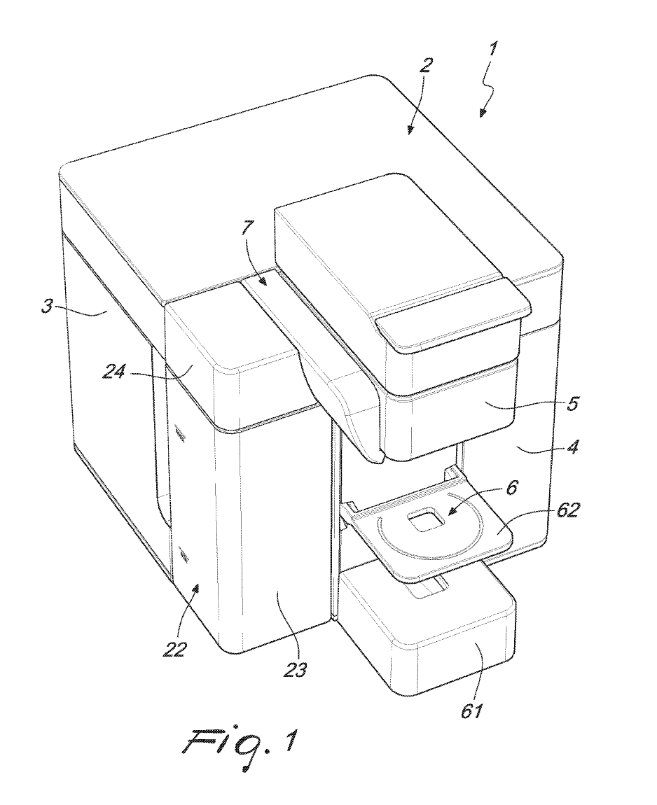

FIG. 1 is a perspective view of a machine for preparing beverages with frothed milk according to the preferred embodiments of the invention;

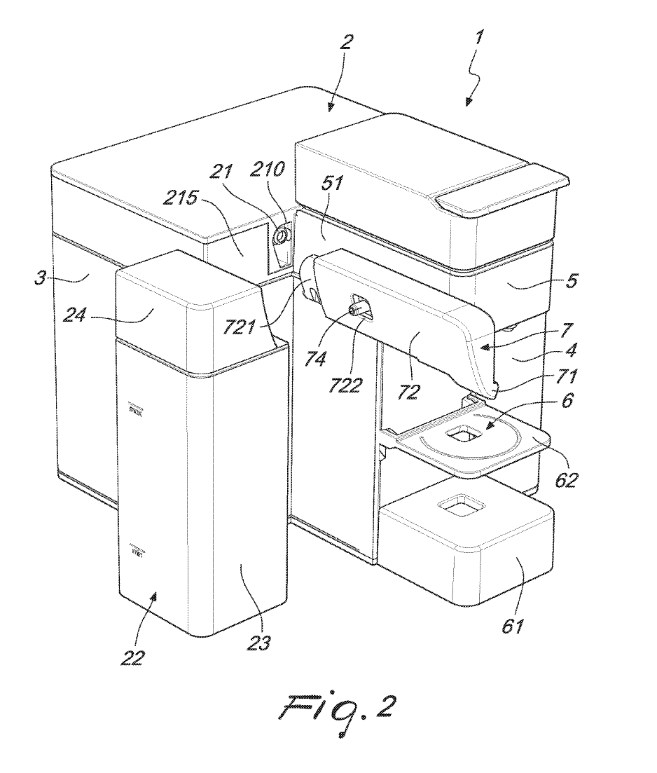

FIG. 2 is an exploded view of the three main components of the machine in FIG. 1;

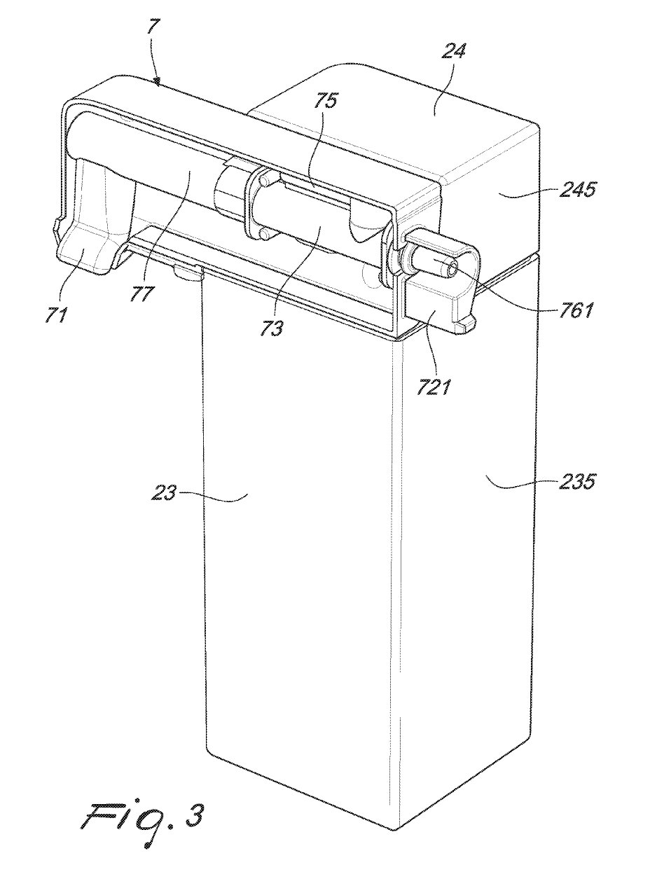

FIG. 3 is a perspective view from the innermost side of the milk reservoir and of the Venturi block according to a first embodiment of the invention when they are mounted on the body shell of the machine in FIG. 1,

FIG. 4 is an exploded view of the components in FIG. 3;

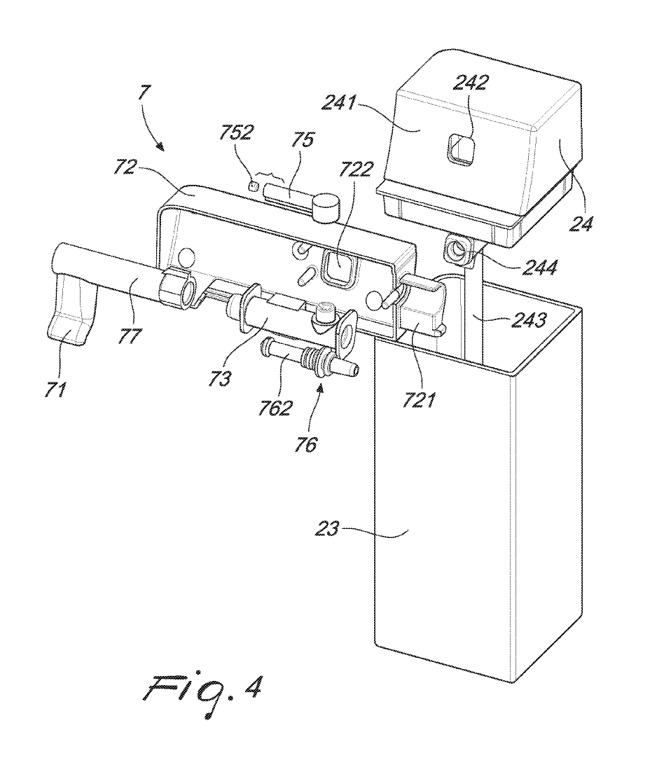

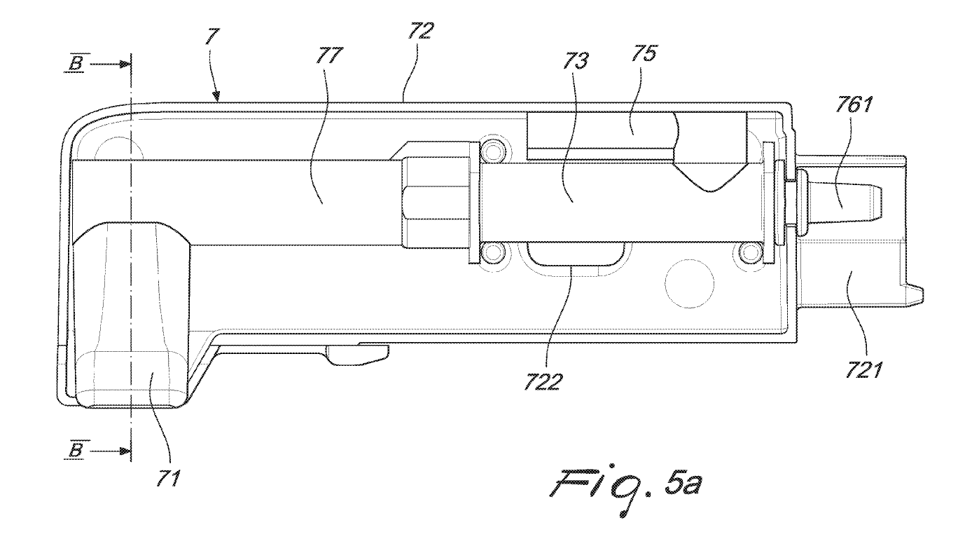

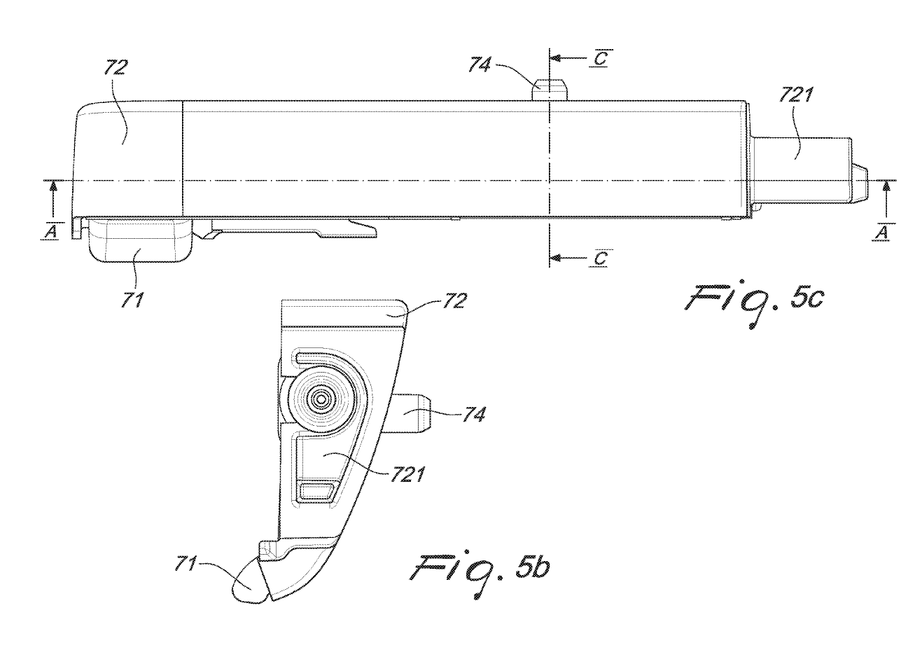

FIGS. 5a, 5b and 5c are respectively a side view, a front elevation view and a plan view from above of the Venturi block of the first embodiment of the invention;

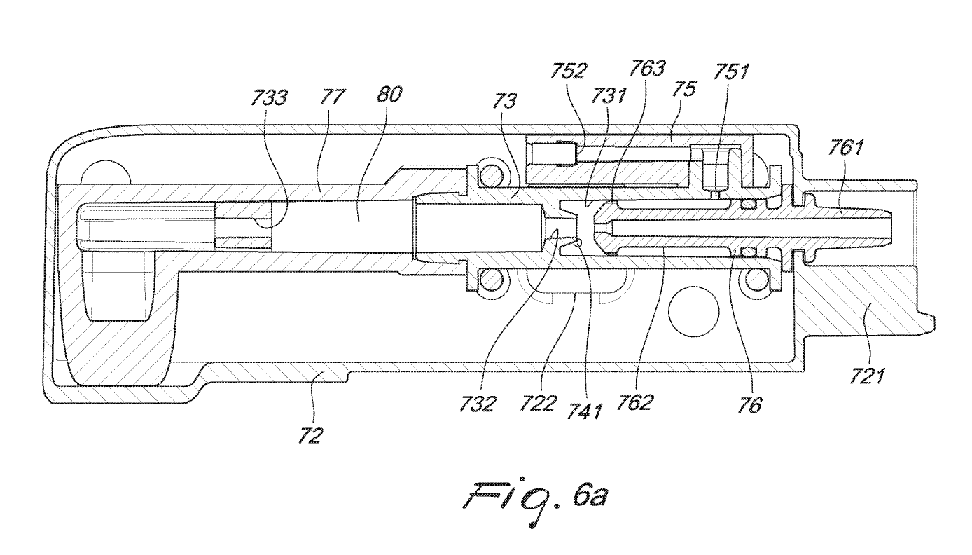

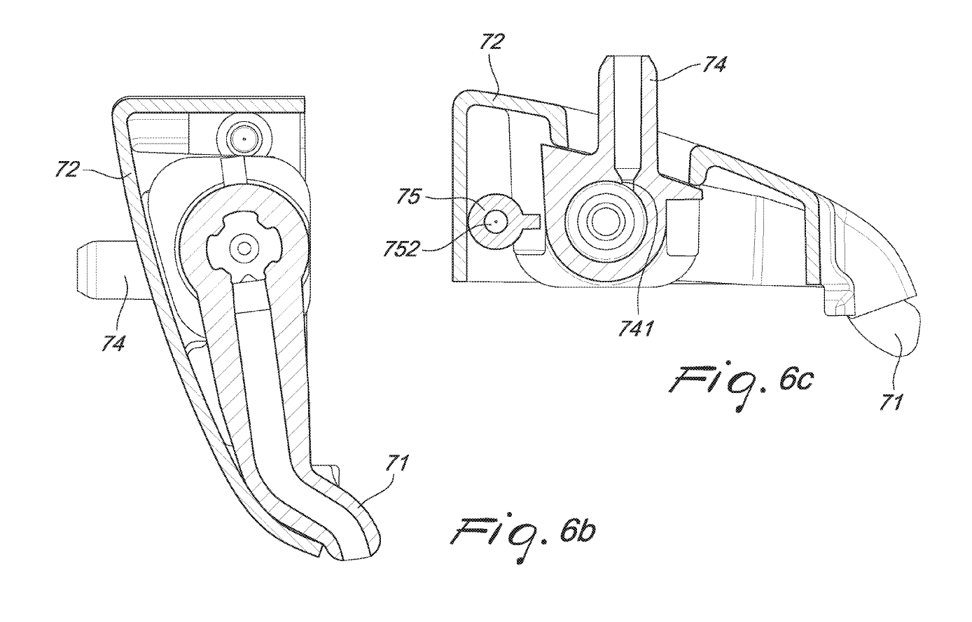

FIGS. 6a, 6b and 6c are respectively cross-sections taken along the planes A, B and C indicated in FIGS. 5a and 5c;

FIG. 7 is a cross-section taken along the plane A of the Venturi block in FIG. 5c which contains an alternative Venturi tube according to a second embodiment of the invention;

FIG. 8 is a perspective exploded view of the Venturi block of a third embodiment of the invention;

FIG. 9 is a cross section of the Venturi tube of FIG. 8 taken along a horizontal plane when in use;

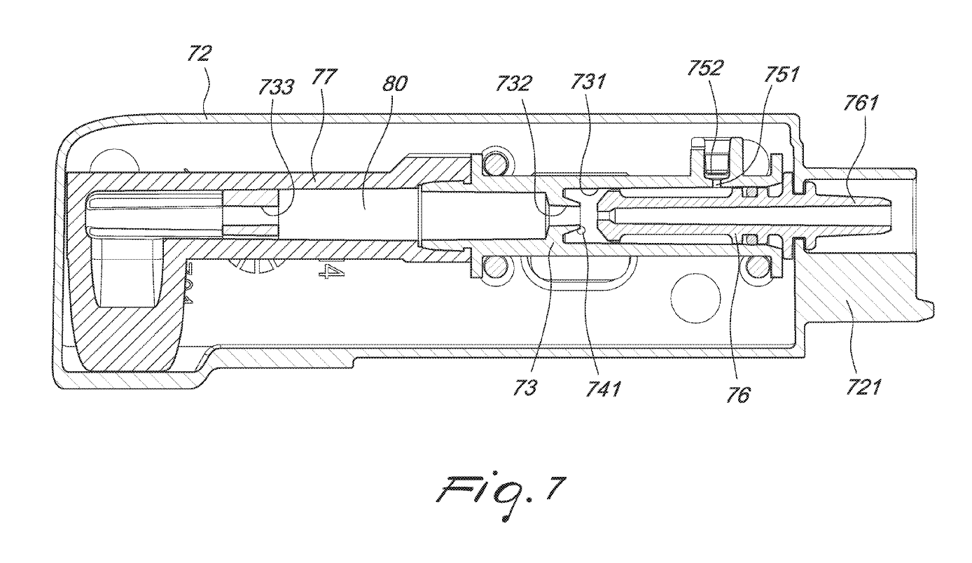

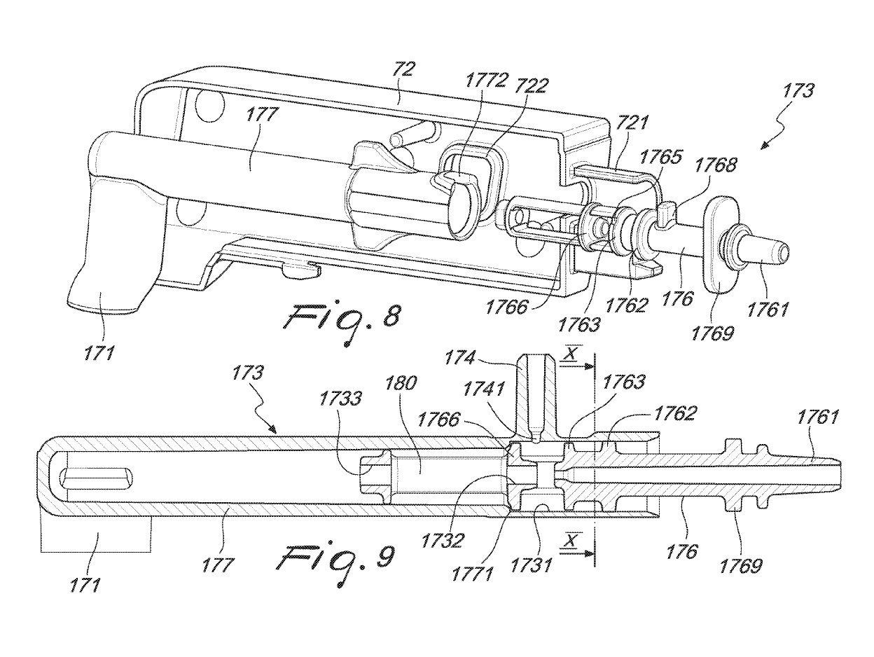

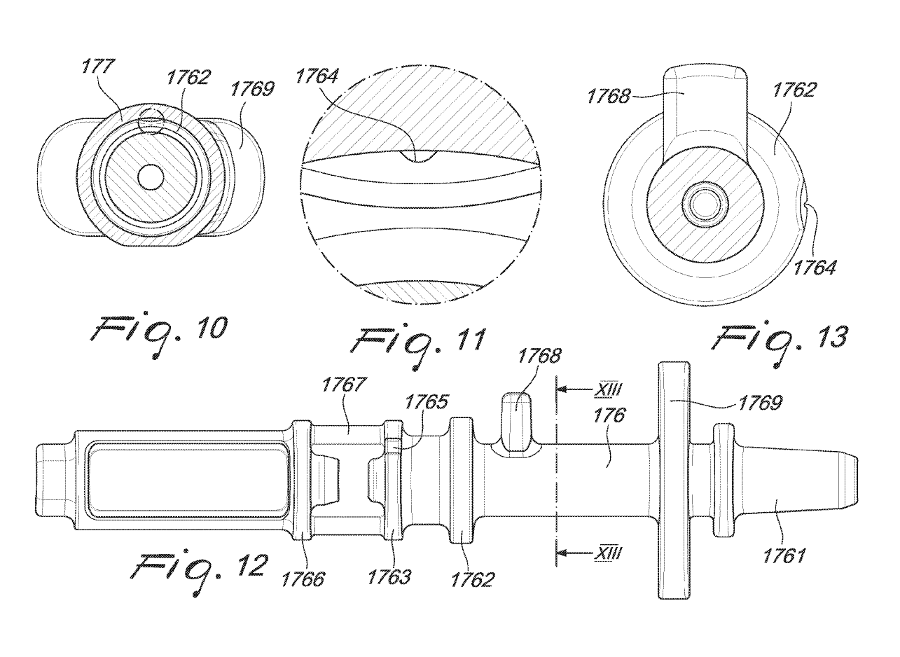

FIG. 10 is a cross section of the Venturi tube of FIG. 8 taken along the X-X plane;

FIG. 11 is a detail of FIG. 10;

FIG. 12 is the internal component of the Venturi tube of FIG. 8;

FIG. 13 is a cross section of the Venturi tube of FIG. 12 taken along the XIII-XIII plane;

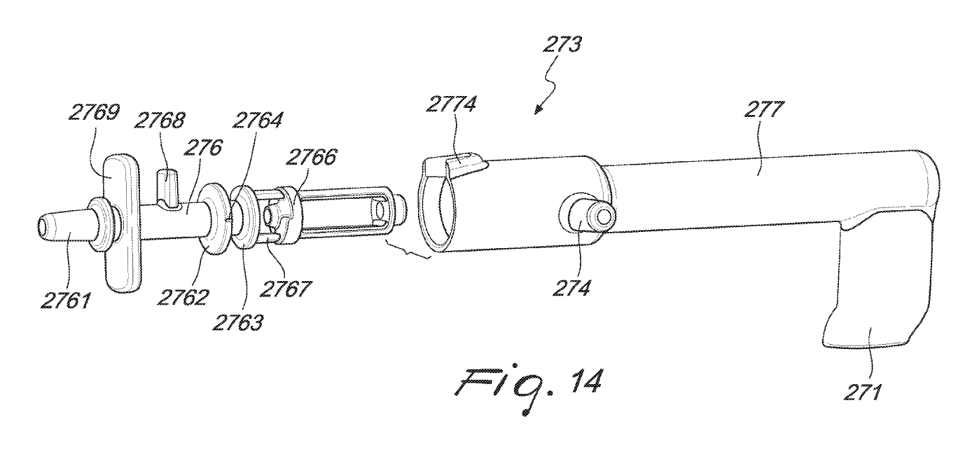

FIG. 14 is a perspective exploded view of the Venturi tube of a fourth embodiment of the invention;

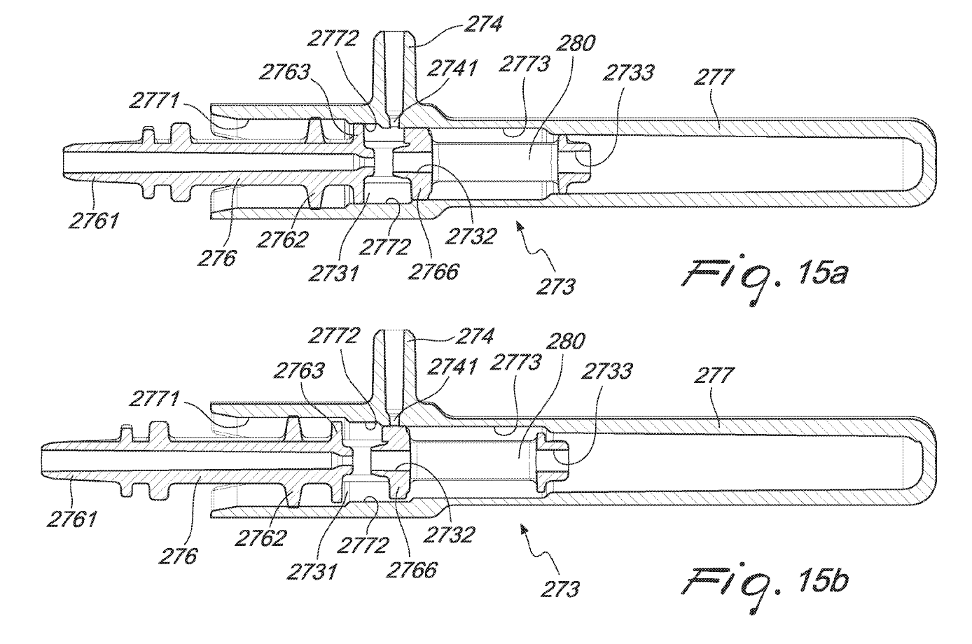

FIG. 15a is a cross section of the Venturi tube of the preceding figure in the milk frothing position, taken along a horizontal plane when in use;

FIG. 15b is a cross section of the Venturi tube of the preceding figure in the self-cleaning position, taken along a horizontal plane when in use;

FIG. 16 is a perspective exploded view of the Venturi tube of a fifth embodiment of the invention;

FIG. 17 is a cross section of the Venturi tube of the FIG. 16 taken along a vertical plane XVII-XVII when in use;

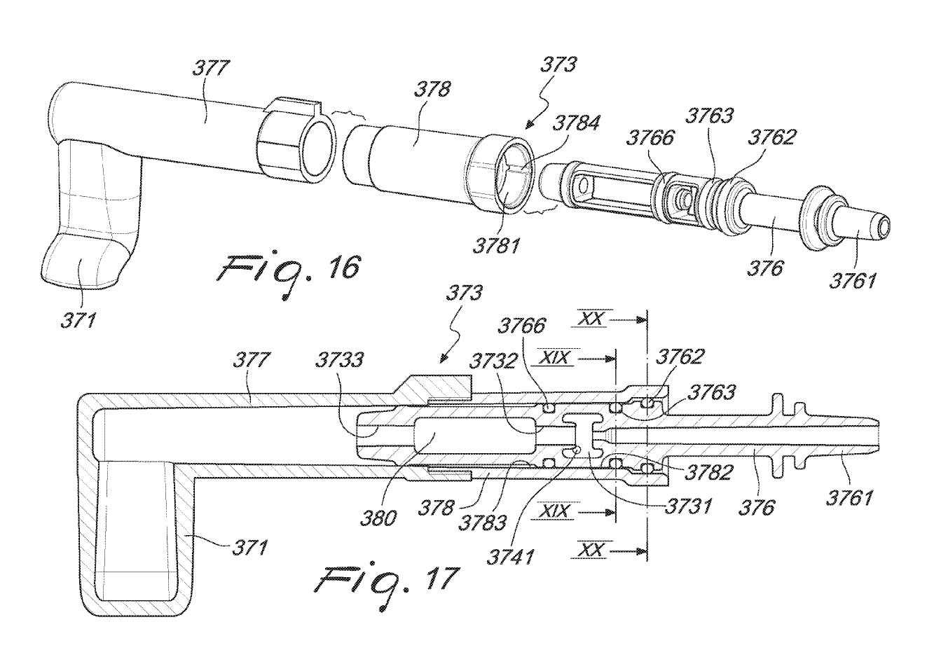

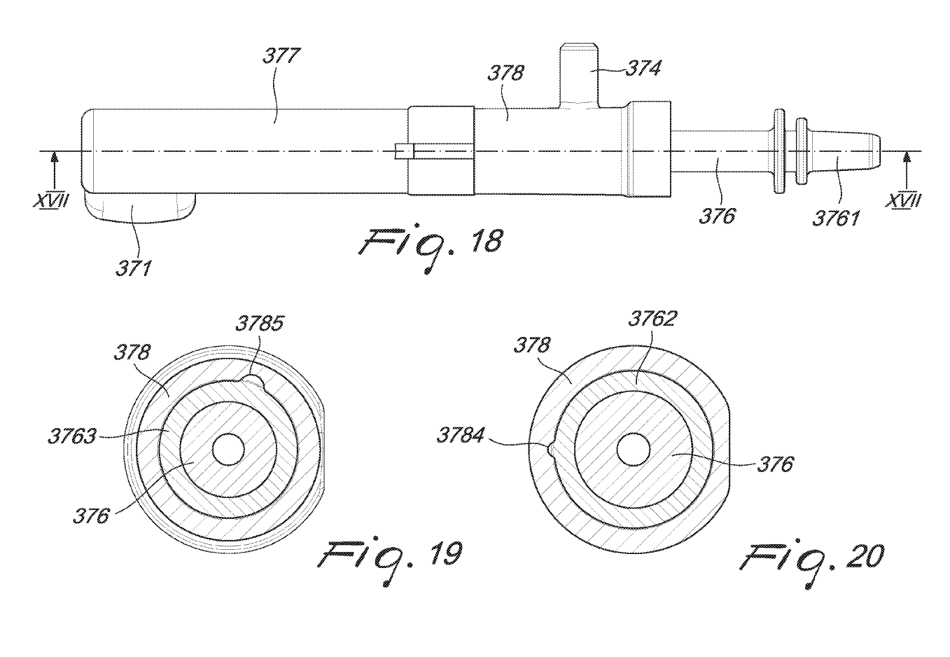

FIG. 18 is a view from above of the Venturi tube of the FIG. 16 when in use;

FIG. 19 is a cross section of the Venturi tube of FIG. 16 taken along the XIX-XIX plane;

FIG. 20 is a cross section of the Venturi tube of FIG. 16 taken along the XX-XX plane.

With reference to the figures and in all the embodiments described hereinafter, the machine for preparing beverages with frothed milk according to the invention, generally designated by the reference numeral 1, comprises a base structure 2 that is adapted to dispense a beverage.

The base structure 2 can be a coffee machine of a type that is known per se, modified so as to also have the characteristics according to the invention. In particular, the base structure 2 has a body shell 3, in which a water reservoir 4 can be accommodated which is preferably extractable from the body shell 3 and which is associated with a water heater and with a pump, which are not shown.

The base structure 2 furthermore comprises a beverage dispensing head 5 below which there is a dispensing region 6 in which it is possible to arrange a container for collecting the dispensed beverage from the dispensing head 5, for example a cup, a beaker or a mug.

The dispensing head 5 preferably comprises a seat, not shown, for a dose of edible substance from which the beverage is to be extracted by way of hot water pumped from the water reservoir 4 to such seat. The edible substance can be ground roasted coffee, soluble coffee, or any edible substance in powder form, in leaves or freeze-dried, or it can consist of a concentrate. Preferably such edible substance is contained in a conventional single-use disposable cartridge. In the description that follows it will be assumed that the edible substance is ground roasted coffee and that the base structure 2 is of the type adapted to dispense espresso coffee.

From the seat for the edible substance, or for the cartridge that contains it, extends a nozzle for the beverage, which is directed toward the dispensing region 6 and can be optionally flanked by a nozzle for hot water only.

The dispensing region 6 can comprise a drip tray 61, which is aligned with the beverage nozzle of the dispensing head 5. Optionally there can also be a holder 62 for supporting espresso coffee cups or cappuccino cups, and such holder can tilt in order to allow the user to also use the drip tray 61 as a support for taller containers, such as mugs or glasses, when the surface of the holder 62 is arranged in a substantially vertical position.

The base structure 2 also comprises a steam outlet 21, and also a milk reservoir 22 that can be separated from the base structure 2.

The milk reservoir 22 has a beaker-like body 23 into which the milk is poured by a user prior to fixing it to the base structure 2. The beaker-like body 23, which can have an essentially parallelepiped shape like the one shown, is closed in an upward region by a lid 24, so as to be able to preserve its contents when the milk reservoir 22 is separated from the base structure 2 in order to be conserved, for example, in a refrigerator with the remaining milk that it contains.

The steam outlet 21 is the end part of a generator of steam under pressure, not shown, of a type that is known per se and which is used in wand frothing devices for cappuccino. The steam outlet 21 can be accommodated in a female seat 210 of the body shell 3 in order to allow the fixing in position of a Venturi block, generally designated by the reference numeral 7 in all the embodiments described hereinafter.

The Venturi block 7 can be separated from the base structure 2 and is connected to the steam outlet 21 and to the milk reservoir 22 in order to draw the milk from the reservoir 22 by the Venturi effect and to produce frothed milk.

In all of the preferred embodiments described herein, the Venturi block 7 is connected detachably in a lateral position with respect to the lid 24 of the milk reservoir 22 (i.e. not above or below the lid 24) and comprises a dispensing spout 71, 171, 271, 371 which, during use, is directed toward the dispensing region of the beverage 6, so as to dispense the frothed milk directly into the same container into which the beverage is dispensed by the dispensing head 5.

In particular, in all of the preferred embodiments described herein, the Venturi block 7 is interposed between one side 241 of the lid 24 of the milk reservoir 22 and one side 51 of the dispensing head 5 and is insertable by interference in the female seat 210 of the steam outlet 21, by way of a male connector 721 with a shape that is substantially complementary to that of the female seat 210. The side 51 advantageously acts as a sliding guide for aligning the male connector 721 of the Venturi block 7 with the female seat 210 of the steam outlet 21 and enabling their correct coupling.

In all of the preferred embodiments described herein, the male connector 721 is integrated in a shell 72 of the Venturi block 7, inside which are fixed the components necessary for drawing the milk from the reservoir 22, frothing it and dispensing it into the region 6.

In particular, in all of the preferred embodiments described herein, the shell 72 has a first lateral window 722 that faces a second lateral window 242 defined on the lid 24 of the milk reservoir 22 when the Venturi block 7 and the milk reservoir 22 are mounted on the base structure 2.

Fixed on the concave part of the shell 72 is a Venturi tube 73, 173, 273, 373 which comprises a milk inlet 74, 174, 274, 374 that faces the first window 722, preferably passing through it so as to protrude outside the Venturi block 7, as shown for example in FIG. 2. The milk inlet 74, 174, 274, 374, which is of the male type and protrudes laterally from the Venturi block 7, is connected to an inner channel 731, 1731, 2731, 3731 of the Venturi tube 73, 173, 273, 373 through the orifice 741, 1741, 2741, 3741 and is adjacent to a narrowing 732, 1732, 2732, 3732 of the inner channel 731, 1731, 2731, 3731.

The Venturi block 7 furthermore comprises a steam entry tube 76, 176, 276, 376 which is preferably separate from the inner channel 731, 1731, 2731, 3731 of the Venturi tube 73, 173, 273, 373 and inserted hermetically in it, e.g. by interference fit, so as to leave a coupling 761, 1761, 2761, 3761 that protrudes outside the Venturi tube 73, 173, 273, 373 and is adapted to be inserted in the steam outlet 21 of the base structure 2 of the machine. At the opposite end, in the first and second embodiments, the Venturi tube 73 is fixed by interference fit to a frothed milk outlet tube 77, which ends with the spout 71.

Advantageously, a further restriction 733, 1733, 2733, 3733 is provided within the frothed milk outlet tube 77, 177, 277, 377 and downstream of the narrowing 732, 1732, 2732, 3732 in order to define an emulsifying chamber 80, 180, 280, 380 therebetween. While in the first and second embodiments the further restriction 733 is integrated into the frothed milk outlet tube 77, in the third to fifth embodiments the further restriction 1733, 2733 and 3733 is integrated in the steam entry tube 176, 276, 376 at a distance from the narrowing 1732, 2732, 3732.

In the third and fourth embodiments, the inner channel 1731, 2731 of the Venturi tube 173, 273 and a frothed milk outlet tube 177, 277 that includes the frothed milk dispensing spout 171, 271 are formed as a single piece, which reduces the overall number of pieces of the Venturi block with respect to the first, second and fifth embodiments and further simplifies the cleaning and maintaining operations.

In the fifth embodiment, the inner channel 3731 of the Venturi tube 373 is provided in an interconnection tube 378, which is fixed by interference fit to the steam entry tube 376 at one end and, at the other end, to a frothed milk outlet tube 377 that includes the frothed milk dispensing spout 371.

The above connectability between the components of the Venturi block 7 allows an easy disassembly and reassembly thereof when cleaning or maintenance operations have to be performed. However, the invention is not limited to the number of axially connectable components of the Venturi block and the Venturi tube as shown in the figures. For instance, the steam entry tube and/or the frothed milk outlet tube may be composed of a number of tubular sub-components that are mutually connectable, e.g. by interference fit, so as to form the same steam entry tube and/or frothed milk outlet tube of the figures.

The steam entry tube 76, 176, 276, 376 and the frothed milk outlet tube 77, 177, 277, 377 are preferably made of two different materials, one of which is elastically deformable and the other one is substantially rigid. For instance, the steam entry tube 76, 176, 276, 376 is made of a rigid material such as plastics and the frothed milk outlet tube 77, 177, 277, 377, the tube 73 and the interconnection tube 378 are made of an elastically deformable material such as silicone rubber. As alternatives, in all the embodiments it would be possible to use the same elastically deformable material for both the steam entry tube and the frothed milk outlet tube, or to use an elastically deformable material for the steam entry tube only.

In the first and second embodiments, the steam entry tube 76 has an annular recess 762 that, when it is inserted in the Venturi tube 73, defines an interspace into which an air intake 751 leads and which is connected to at least one notch 763.

The air intake 751 is also connected to an air intake channel 75, which is internally tapered toward the air intake 751 and has, at the opposite end, an air flow calibrator 752, which defines a narrowing with respect to the air intake channel 75 and to the air intake 751.

In the second embodiment, shown in FIG. 7, the air flow calibrator 752 can be provided directly on the Venturi tube 73 in a position adjacent to the air intake 751, as a consequence eliminating the air intake channel 75.

In the third, fourth and fifth embodiments, the Venturi tube 173, 273 and 373 does not include an air intake of the radial kind such as in the preceding embodiments, but the air intake is formed in a substantially axial direction, between the steam entry tube 176, 276 and the frothed milk outlet tube 177, 277, or between the steam entry tube 376 and the interconnection tube 378.

Moreover, in the third, fourth and fifth embodiments the steam entry tube 176, 276, 376 is externally provided with a plurality of radial rings 1762, 1763, 1766, 2762, 2763, 2766, 3762, 3763, 3766 that are adapted to define respective radial seals against the inner channel 1731, 2731, 3731 of the Venturi tube 173, 273, 373 at different axial positions and to leave respective axial air intakes upstream of the mixing chamber in which milk, air and steam are mixed together.

In particular, in the third embodiment the steam entry tube 176 has a first annular rib 1762 which has an external diameter suitable for defining a substantially watertight seal with the inner surface of the frothed milk outlet tube 177 and which includes at least one first axial air intake 1764, such as a notch on its periphery or an axial groove on such inner surface, which is suitable to draw air from the outside into the Venturi tube 173 for frothing the milk.

In order to maintain such first axial intake 1764 clean from milk, a second annular rib 1763 is also provided on the steam entry tube 176, which also has an external diameter suitable for defining a substantially watertight seal with the inner surface of the frothed milk outlet tube 177 and which has a second axial air intake 1765, such as a notch on its periphery or an axial groove on such inner surface.

Advantageously, the second axial air intake 1765 is not axially aligned with the first air axial intake 1764, so as to avoid direct fluid backflow from the second axial air intake 1765 to the first axial air intake 1764.

The second annular rib 1763 is arranged in a more internal axial position of the Venturi tube 173 than the first annular rib 1762, so as to be axially arranged between the milk orifice 1741 and the first annular rib 1762.

A third annular rib 1766 is also provided on the steam entry tube 176 in a more internal axial position of the Venturi tube 173 than the second annular rib 1763 so that the milk orifice 1741 is arranged between the second annular rib 1763 and the third annular rib 1766.

The third annular rib 1766 has an external diameter suitable for defining a substantially watertight seal with the inner surface of the frothed milk outlet tube 177 and defines, together with such inner surface and the second annular rib 1763, a mixing chamber in which steam, air and milk are mixed together. The third annular rib 1766 also bounds, together with the frothed milk outlet tube 177 and the restriction 1733, the emulsifying chamber 180 downstream of the mixing chamber.

The third annular rib 1766 is also used in cooperation with an inner step 1771 of the frothed milk outlet tube 177 for defining a correct end-stop position when the steam entry tube 176 is inserted into the frothed milk outlet tube 177.

Advantageously, the second annular rib 1763 and the third annular rib 1766 are mutually connected so as to define a window facing the milk orifice 1741. More particularly, the second annular rib 1763 and the third annular rib 1766 may be mutually connected only through bridges 1767.

Advantageously, in order to avoid that the milk orifice 1741 be occluded by an incorrectly inserted steam entry tube 176, a foolproof structure is provided on the Venturi tube 173, which may include a radial tongue 1768 on the steam entry tube 176 and a corresponding axial recess 1772 on the frothed milk outlet tube 177, in which the radial tongue 1768 is inserted for obtaining a correct angular position between the steam entry tube 176 and the frothed milk outlet tube 177 that prevents the risk of occluding the milk orifice 1741.

Optionally, the steam entry tube 176 may also comprise a finger grip 1769 for facilitating the manual removal of the steam entry tube 176 from the frothed milk outlet tube 177 when the Venturi tube 173 has to be disassembled for cleaning or maintenance operations.

The fourth embodiment differs from the third embodiment in that the Venturi tube 273 provides for both a milk frothing position and a self-cleaning position, based on the mutual axial arrangement of the steam entry tube 276 and the frothed milk outlet tube 277.

Specifically, in the fourth embodiment the steam entry tube 276 has a first annular rib 2762 which has an external diameter suitable for defining a substantially watertight seal with a first inner surface 2771 of a first portion of the frothed milk outlet tube 277 and which includes at least one first axial air intake 2764, such as a notch on its periphery or an axial groove on such first inner surface 2771, which is suitable to draw air from the outside into the Venturi tube 273 for frothing the milk.

In order to maintain such first axial intake 2764 clean from milk, a second annular rib 2763 is also provided on the steam entry tube 276, which also has an external diameter suitable for defining a substantially watertight seal with a second inner surface 2772 of a second portion of the frothed milk outlet tube 277 and which has a second axial air intake (not shown in the drawings), such as a notch on its periphery or an axial groove on such second inner surface 2772.

In the fourth embodiment, the second axial air intake is also not axially aligned with the first air axial intake 2764, so as to avoid direct fluid backflow from the second axial air intake to the first axial air intake 2764. The second annular rib 2763 is arranged in a more internal axial position of the Venturi tube 273 than the first annular rib 2762, so as to be axially arranged between the milk orifice 2741 and the first annular rib 2762 when frothing the milk.

A third annular rib 2766 is also provided on the steam entry tube 276 in a more internal axial position of the Venturi tube 273 than the second annular rib 2763 so that the milk orifice 2741 is arranged between the second annular rib 2763 and the third annular rib 2766 in the milk frothing position.

The third annular rib 2766 has an external diameter suitable for defining a substantially watertight seal with a third inner surface 2773 of the frothed milk outlet tube 277 and defines, together with the second inner surface 2772 and the second annular rib 2763, a mixing chamber in which steam, air and milk are mixed together. The third annular rib 2766 also bounds, together with the frothed milk outlet tube 277 and the restriction 2733, the emulsifying chamber 280 downstream of the mixing chamber.

The second annular rib 2763 and the third annular rib 2766 are mutually connected so as to define a window facing the milk orifice 2741. More particularly, the second annular rib 2763 and the third annular rib 2766 may be mutually connected only through bridges 2767.

As in the third embodiment, the Venturi tube 273 includes a foolproof structure composed of a radial tongue 2768 of the steam entry tube 276 cooperating with a corresponding axial recess 2774 of the frothed milk outlet tube 277, in order to obtain a correct angular position between the steam entry tube 276 and the frothed milk outlet tube 277.

Optionally, the steam entry tube 276 may also comprise a finger grip 2769 for facilitating the manual removal of the steam entry tube 276 from the frothed milk outlet tube 277 when the Venturi tube 273 has to be disassembled for cleaning or maintenance operations.

The third annular rib 2766 can be advantageously used to occlude the milk orifice 2741 when the steam entry tube 276 is in the self-cleaning position, i.e. when the steam entry tube 276 is partially pulled out from the frothed milk outlet tube 277, i.e. is pulled in the left direction of FIG. 15a, until the lateral surface of the third annular rib 2766 faces the milk orifice 2741, as shown in FIG. 15b.

To this aim, the radial extension of the annular ribs of the steam entry tube 276 and the radial extension of the respective inner surfaces against which the annular ribs provide a radial seal in the milk frothing position are such that, when the steam entry tube 276 is positioned to as to occlude the milk orifice 2741, no watertight seals are maintained anymore between the steam entry tube 276 and the frothed milk outlet tube 277.

Specifically, the diameter of the first annular rib 2762 is greater than the diameter of the second annular rib 2763, which is in turn greater than the diameter of the third annular rib 2766. Similarly, the mean diameter of the first inner surface 2771 of the frothed milk outlet tube 277 is greater than the mean diameter of the second inner surface 2772, which is greater than the mean diameter of the third inner surface 2773.

However, the radial extension of the second inner surface 2772 features a reduction at the milk orifice 2741 which is suitable to maintain the edge of the milk orifice 2741 flush with the third inner surface 2773. In this way, when the steam entry tube 276 is partially pulled out from the frothed milk outlet tube 277 with respect to the milk frothing position, the third annular rib 2766 occludes the milk orifice 2741 but is not able to maintain a watertight seal with the second inner surface 2772 at the diametrically opposite position with respect to the angular position of the milk orifice 2741, as shown in FIG. 15b.

Moreover, the axial distance between the second annular rib 2763 and the third annular rib 2766 is such that, in the above position in which the third annular rib 2766 occludes the milk orifice 2741, the second annular rib 2763 is placed in the first portion of the frothed milk outlet tube 277 and, because of its lower diameter, is not able to maintain a watertight seal with the first inner surface 2771.

In the self-cleaning position described above, when the machine 2 is operated as for frothing the milk, the steam will enter the steam entry tube 276 and will clean the chambers between the first annular rib 2762 and the second annular rib 2763 and between the second annular rib 2763 and the third annular rib 2766 up to the dispensing spout 271.

In the fifth embodiment, the substantially watertight seal between the steam entry tube 376 and the interconnection tube 378 is obtained through O-rings that are arranged at difference axial positions along the steam entry tube 376. Such O-rings may be fixed at these positions by interference fit, as in the figures, or may be over-molded on the steam entry tube 376 at those positions.

Specifically, the steam entry tube 376 has a first O-ring 3762 which has an external diameter suitable for defining a substantially watertight seal with a first portion 3781 of the inner surface of the interconnection tube 378.

The interconnection tube 378 includes at least one first axial air intake 3784, such as an axial groove on the first portion 3781 of its internal surface, which is suitable to draw air from the outside into the Venturi tube 373 for frothing the milk.

The steam entry tube 376 also has a second O-ring 3763, which has an external diameter suitable for defining a substantially watertight seal with a second portion 3782 of the inner surface of the interconnection tube 378. The second O-ring 3763is arranged in a more internal axial position of the Venturi tube 373 than the first O-ring 3762, so as to be axially arranged between the milk orifice 3741 and the first O-ring 3762.

The interconnection tube 378 includes at least one second axial air intake 3785, such as an axial groove on the second portion 3782 of its internal surface, which is suitable to draw air from the outside into the Venturi tube 373 for frothing the milk. The angular position of the second axial air intake 3785 is different from the angular position of the first axial air intake 3784, in order to maintain such first axial intake 3784 clean from milk by preventing direct fluid backflow from the second axial air intake 3785 to the first axial air intake 3784.

The steam entry tube 376 also has a third O-ring 3766, which has an external diameter suitable for defining a substantially watertight seal with a third portion 3783 of the inner surface of the interconnection tube 378 and for defining, together with the second and third inner surfaces 3782 and 3783 and the second O-ring 3763, a mixing chamber in which steam, air and milk are mixed together. The third O-ring 3766 also bounds, together with the interconnection tube 378 and the restriction 3733, the emulsifying chamber 380 downstream of the mixing chamber.

The third O-ring 3766 is fit on the steam entry tube 376 in a more internal axial position in the Venturi tube 373 than the second O-ring 3763 so that the milk orifice 3741 is arranged between the second O-ring 3763 and the third O-ring 3766.

In other embodiments of the invention, not shown in the drawings, the steam entry tube may comprise both annular ribs and O-rings for defining radial rings used for forming a watertight seal with the inner surface of the frothed milk outlet tube.

The lid 24 of the milk reservoir 22 comprises a milk riser 243 which is connected to the second window 242 of the lid. In particular, the riser 243 has a milk outlet 244 the rim of which is fixed by interference on the rim of the second window 242 and in which the milk inlet 74 of the Venturi block 7 is insertable by interference. The coupling between the milk inlet 74 and the milk outlet 244 of the riser 243 is of the detachable type.

The milk reservoir 22 has a first side wall that, in the example shown, is planar and is formed by a first flat flank 245 of the lid and by a second flat flank 235 of the beaker-like body 23, which are mutually co-planar. The first side wall formed by the sides 235 and 245 can slide on a corresponding guiding second side wall 215 of the base structure 2 which is complementary to the first side wall, so that the sliding of the first side wall on the second makes it possible to automatically align the first window 242 with the second window 722, i.e. the milk outlet 244 of the reservoir 22 with the milk inlet 74, 174, 274, 374 of the Venturi block 7.

The operation of the invention is evident from the foregoing description of its structure. In the case shown, in which the machine is adapted to the preparation of cappuccino and latte macchiato, the base structure 2 of the machine is adapted to dispense espresso coffee by way of injection of hot water under pressure in a cartridge containing ground roasted coffee, which is inserted in an adapted extraction seat in the dispensing head 5. The user inserts such a cartridge in the dispensing head 5. Before or after the insertion of the cartridge, if the milk reservoir 22 is empty, the user separates it manually from the base structure 2 by way of a traction movement exerted transversely with respect to the side of the dispensing head 5, leaving the milk inlet 74 visible. Thanks to the male connector 721 integrated in the shell 72, the internal components of the Venturi block 7 are not subjected to significant stresses, which are instead absorbed by the shell 72.

Subsequently, removing the lid 24, the user fills the beaker-like body 23 with milk, up to a certain allowed level. After having closed the lid 24 again, the reservoir 22 is brought laterally toward the dispensing head, by sliding the sides 235 and 245 on the guiding second side wall 215 until the milk inlet 74 is coupled to the milk outlet 244 of the riser 243.

Then, by activating a “cappuccino” or “latte macchiato” mode of the machine 1, the water pump is activated so as to draw it from the water reservoir 4, pass it through the heater and finally inject it into the extraction chamber of the dispensing head 5, in particular into the cartridge containing the ground roasted coffee, from which the extracted coffee is finally dispensed into a cup arranged in the dispensing region 6.

At the same time as, or after, the dispensing of the espresso coffee, the steam generator is activated for a certain time interval so as to inject, through the steam outlet 21 and the coupling 761, the steam into the Venturi block 7. By the Venturi effect, the block 7 will draw air from the air intake 751 and the milk of the reservoir 22 through the milk inlet 74, 174, 274, 374 connected to the riser 243. The air/steam/milk mixture will make it possible to froth the milk, which thanks to the pressure of the steam generator will exit from the spout 71, 171, 271, 371 to be dispensed directly into the cup of the dispensing region 6. The steam generator will be programmed for the time necessary to dispense a quantity of frothed milk typical of a cappuccino or of a latte macchiato.

After the dispensing, the user can separate the milk reservoir 22 with the corresponding lid 24 and wash it, or conserve it in a refrigerator if the beaker-like body 23 still contains milk. The user can also separate the Venturi block 7 in order to wash it.

In practice it has been found that the device according to the invention fully achieves the set aim in that it is possible to mount and dismount the components of a machine for preparing beverages with frothed milk so that the parts for fluid interconnection between the Venturi block, the milk reservoir, and the machine are clearly visible during the mounting, thus facilitating the operations of mounting and dismounting, as well as the washing, of the component parts.

Furthermore, the machine is contoured so as to guide the user in the mounting of the milk reservoir and of the Venturi block.

Although the machine according to the invention has been conceived in particular for preparing cappuccino and latte macchiato, it can in any case be used, more generally, for preparing beverages based on frothed milk.

The machine, thus conceived, is susceptible of numerous modifications and variations, all of which are within the scope of the appended claims. Moreover, all the details may be substituted by other, technically equivalent elements.

In practice, the materials employed, as well as the dimensions, may be any according to requirements and to the state of the art.

The disclosures in Italian Patent Application No. MI2014A001771 from which this application claims priority are incorporated herein by reference.

1-20. (canceled)

21. A machine for preparing beverages with frothed milk, particularly cappuccino or latte macchiato, which comprises a base structure adapted to dispense a beverage, particularly coffee, and provided with a dispensing head below which there is a dispensing region in which it is possible to arrange a container for collecting the dispensed beverage, said base structure comprising a steam outlet and a milk reservoir that can be separated from the base structure, said milk reservoir comprising a lid, said base structure comprising furthermore a Venturi block that can be separated from the base structure and is connected to said steam outlet and to said milk reservoir in order to draw the milk from said milk reservoir by the Venturi effect and to produce frothed milk, wherein said Venturi block is interposed between said dispensing head and said lid of the milk reservoir and is connected detachably to said lid of the milk reservoir in a lateral position with respect to said lid.

22. The machine according to claim 21, wherein said Venturi block comprises a dispensing spout that is directed toward said dispensing region.

23. The machine according to claim 21, wherein said base structure comprises a guiding surface for said milk reservoir and is adapted to align, by way of a sliding of said milk reservoir along said guiding surface, a milk inlet of said Venturi block with a milk outlet of said milk reservoir.

24. The machine according to claim 21, wherein said dispensing head comprises a side on which said Venturi block can slide in order to mate with said steam outlet.

25. The machine according to claim 21, wherein said Venturi block comprises a shell provided with a first lateral window and said lid comprises a second lateral window that faces the first lateral window when said Venturi block and said milk reservoir are mounted on the base structure, said Venturi block comprising a milk inlet which faces said first lateral window and said lid comprising a milk riser that is connected to said second lateral window.

26. The machine according to claim 25, wherein said milk inlet belongs to a Venturi tube that is fixed on said shell and is connected detachably to said steam outlet, said Venturi tube furthermore comprising an air intake.

27. The machine according to claim 26, wherein the connection between said Venturi tube and said steam outlet and/or the connection between said milk inlet and said milk riser is of the type with interference fit.

28. The machine according to claim 26, wherein said air intake is connected to an air flow calibrator.

29. The machine according to claim 26, wherein said Venturi tube comprises a steam entry tube removably inserted into an inner channel of the Venturi tube, the steam entry tube being provided with a plurality of radial rings that are adapted to define respective radial seals against respective portions of the internal surface of said inner channel at different axial positions, at least one axial air intake being provided at at least one of said radial seals upstream of a mixing chamber in which the milk from said milk reservoir and the steam from said steam outlet are mixed together.

30. The machine according to claim 29, wherein said radial rings comprise annular ribs and/or O-rings.

31. The machine according to claim 28, in which said at least one axial air intake is an axial notch on said radial ring or an axial groove on said internal surface of said inner channel of the Venturi tube.

32. The machine according to claim 29, wherein said radial rings are arranged at three different axial positions of said steam entry tube so that a first and a second of said radial rings and their respective axial air intakes are arranged upstream of an outlet orifice of the milk inlet in the direction of the steam from the steam outlet and a third radial ring is arranged downstream of the outlet orifice of the milk inlet in the direction of the steam from the steam outlet, so that said chamber in which the milk from said milk reservoir and the steam from said steam outlet are mixed together with the air from said axial air intakes is arranged between said second and third radial rings.

33. The machine according to claim 29, in which said axial air intakes are arranged at angular positions which are different from one another.

34. The machine according to claim 32, wherein the radial extension of said radial rings of the steam entry tube and the radial extension of said respective portions of the internal surface of said inner channel are such that, when the steam entry tube is axially displaced with respect to said internal surface of said inner channel, the third radial rings occludes the outlet orifice of said milk inlet and no watertight seals are maintained anymore between said radial rings and said respective portions of the internal surface of said inner channel, so that the steam from said steam outlet can enter said inner channel without drawing milk from the milk inlet.

35. The machine according to claim 29, wherein said inner channel of the Venturi tube is provided by a frothed milk outlet tube, said steam entry tube and said frothed milk outlet tube being made of the same material or of two different materials, one of said two different materials being less rigid than the other one.

36. The machine according to claim 35, wherein said less rigid material is an elastically deformable material such as silicone rubber or silicone resin.

37. The machine according to claim 21, wherein said Venturi block comprises a mixing chamber where the milk from said milk reservoir, the steam from said steam outlet and air are drawn and mixed, said Venturi block further comprising an emulsifying chamber downstream of said mixing chamber in the direction of the steam from said steam outlet.

38. The machine according to claim 37, wherein said mixing chamber and said emulsifying chamber are bounded by at least some of said radial rings, one of said radial rings bounding both said mixing chamber and said emulsifying chamber and comprising a narrowing through which the mixture of milk, steam and air is drawn to the emulsifying chamber.

39. The machine according to claim 21, wherein said base structure comprises a water reservoir, a heater and a pump, said dispensing head comprising a seat for a dose of edible substance from which said beverage is to be extracted by way of the heated water pumped from said water reservoir to said seat.

40. The machine according to claim 39, wherein said dose is contained in a single-use cartridge.
